(19) United States
(12) Patent Application Publication
(10) Pub. No.: US 2008/0235255 A1
(43) Pub. Date: Sep. 25, 2008

(54) Extensible Data Repository

(75) Inventors: Kevin Glen Roy Greer, Mississauga (CA); Rubens Rahim, Langley (CA)

Correspondence Address: PATENT ADMINISTRATOR;KATTEN MUCHIN ROSENMAN LLP, 2900 K Street NW, Suite 200, WASHINGTON, DC, 20007-5118, US

(73) Assignee: Redknee Inc., Mississauga (CA)

(21) Appl. No.: 11/688,078

(22) Filed: Mar. 19, 2007

(51) Int. Cl. G06F 17/30

(52) U.S. Cl. 707/102; 707/E17.001

(57) ABSTRACT

In telecommunication networks, the need for real-time extension of data repositories is increasing. The present application provides an extensible data repository that can be used by a plurality of different applications that each has a local data format structure and database command structure. A single data repository is available to all of the applications. A universal dynamic storage application resides between the common database and the applications, and permits each application to interact with the common database according to its local format structure and database command structure.

### FIELD OF THE INVENTION

The present invention relates to data management and more particularly relates to an extensible data repository for use in management of telecommunication subscriber profiles or the like.

### BACKGROUND OF THE INVENTION

Client devices, in the form of desktop computers, laptop computers, personal digital assistants, cellular telephones, wireless email pagers, portable audio devices, portable video devices continue to become more ubiquitous and the various functionalities of each are merging, leading to the creation of multi-function client devices that can perform two or more functions including voice telephony, email, web-browsing, chat, music, video, calendaring, contact management and location services. Multi-function client devices benefit from, and depend upon, a robust and complex wired and wireless network infrastructure to allow multi-function client devices to connect with each other and/or with servers that host applications that are of interest to subscribers of such client devices.

Thus, network infrastructure must also keep pace with the advances of multi-function devices in order to allow such devices to operate to their full potential. Carriers are motivated to enhance their network infrastructures in order to maximize the revenue potential associated with the provision of services to multi-function devices. Of particular note, within the context of wireless portable multi-function client devices, carrier network infrastructure needs to provide services in real-time, to devices that are moving between base station coverage areas and/or roaming between different carriers. However, for the carrier to justify provision of such an enhanced network, the carrier must also ensure revenue is captured for the provision of such services. Thus, significant challenges also exist in providing real-time billing to accompany the provision of real-time services. Challenges are compounded by the need to update and/or upgrade the network as services and subscribers are added, removed or changed, without interrupting operation of the network which must operate twenty-four hours a day, seven days per week.

### SUMMARY OF THE INVENTION

In telecommunication networks, the need for real-time extension of data repositories is increasing. The present application provides an extensible data repository that can be used by a plurality of different applications that each has a local data format structure and database command structure. A single data repository is available to all of the applications. A universal dynamic storage application resides between the common database and the applications, and permits each application to interact with the common database according to its local format structure and database command structure.

An aspect of the invention provides a method of operating a data repository comprising:

receiving a local database definition from a local application that utilizes the local database definition;

comparing fields in a universal database with the local database definition;

generating a viewing strategy for the local application; the viewing strategy based on results of the comparing;

creating a view for the local application according to the local database definition based on the viewing strategy such that data in the universal database is viewable in the local application according to the local database definition.

The method can further comprise serving the local application from the universal database according to the view.

The viewing strategy can include generating a list of fields that exist in the universal database that have not been used in the local database definition until now.

The viewing strategy can include generating a list of fields that are not common between the universal database and the local database definition but which are compatible.

The method can further comprise establishing read only privileges for the local database definition for the fields which are compatible but not in common. The fields with read only privileges can be, for example, fields in the local database definition that contain only a portion of fields from the universal database. As another example, the list of fields with read only privileges can include fields in the local database definition that are derived from multiple fields in the universal database.

The method can further comprise creating fields in the universal database that exist in the local database definition but do not exist in the universal database.

The fields in the local database can include one or more of subscriber name, device type, service plan offering, Mobile Station International Subscriber Directory Number (“MSISDN”), International Mobile Station Identity (“IMSI”), Tariff Plan, Short Message Service (“SMS”) Counter, International Voice Call Minutes, Local Call Minutes, Free Call Counter, Data Volume Usage, Language, Barred Services, and Voucher Recharges.

The application can be one of a customer resource management application, a bundling application, a location application, a Virtual Private Networking application, a Location Based Billing application, a Prepaid billing application, a Missed Call Return application, a Loyalty Reward and Promotion Program application, a Fraud Management application, a Policy Management application, a Call Screening and Redirection application, a Subscriber Profile Management application.

Another aspect provides a data repository system comprising a universal database and a universal database application connected to the universal database. The system can also comprise a plurality of local applications connected to the universal database application. Each of the a local database are configured to utilize a local database definition. The universal database application is configured to receive each the local database definition from the local application and to perform a comparison of fields in the universal database with the local database definition. The universal database application is further configured to generate a viewing strategy for the local application. The viewing strategy is based on results of the comparison. The universal database application is further configured to create a view for the local application according to the local database definition based on the viewing strategy such that data in the universal database is viewable in the local application according to the local database definition.

An aspect provides a method of operating a data repository comprising:

receiving a database command message in a local structure from one of a plurality of applications; each of the applications associated with its own local structure and unique database format; each of the unique database formats sharing at least one common field;

modifying the database command message from the local structure to conform to a universal database structure;

forwarding the command message in the universal database structure to a common database;

receiving a response message, responsive to the command message; from the common database in the universal database structure;

modifying the response message to confirm to the local structure; and

returning the response to the command message in the local structure to the one of the plurality of applications.

### BRIEF DESCRIPTION OF THE DRAWINGS

FIG. 1 shows a prior art data repository system.

FIG. 2 shows a data repository system in accordance with an embodiment.

FIG. 3 shows a flow chart depicting a method of operating a data repository in accordance with another embodiment.

FIG. 4 shows a flow chart depicting a method of adding a database field in accordance with another embodiment.

FIG. 5 shows a flow chart depicting a method of operating a data repository in accordance with another embodiment.

FIG. 6 shows a data repository system in accordance with another embodiment.

### DETAILED DESCRIPTION

Before discussing the present application further, certain terms shall be defined.

“Database structure” means the schema of a database, including the number of fields, the name, type, length and any other parameter associated with each field. Other parameters can include the default value and any constraints associated with the contents of a record associated with that field.

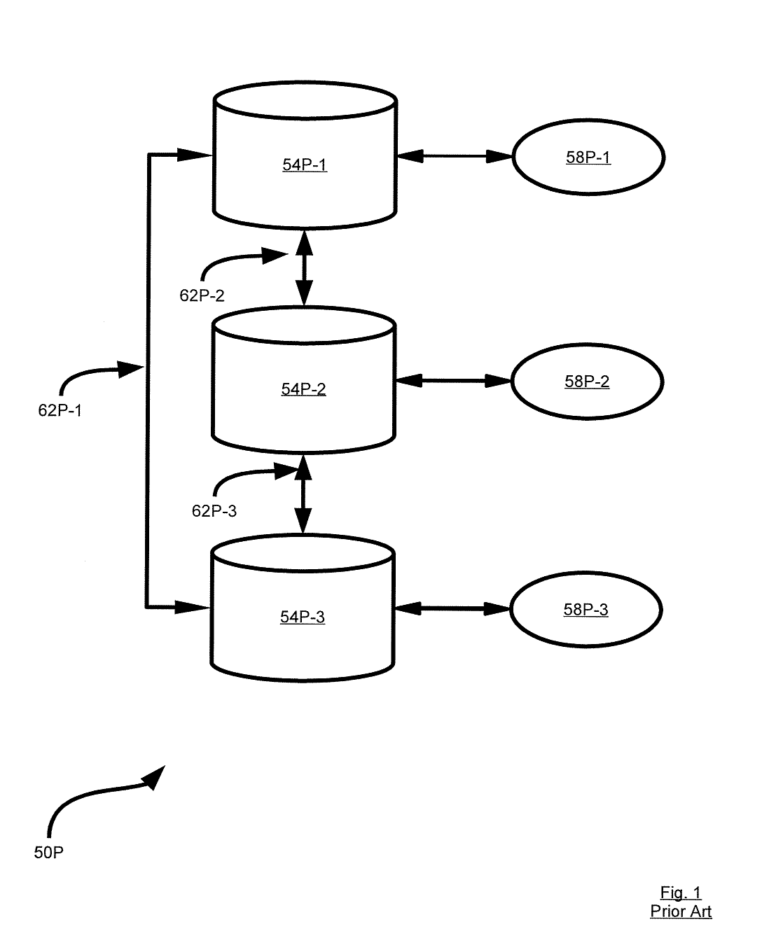

To assist in understanding the present embodiments, FIG. 1 shows a prior art data repository system 50P. The suffix “P” is used to denote “prior art”. System 50P comprises a plurality of databases 54P-1, 54P-2, 54P-3, which are collectively referred to herein as databases 54P and generically as database 54P. (This nomenclature is used elsewhere in this disclosure.) Respective to each database 54P is a network application 58P. Each network application 58P represents a different service or function that is offered by a carrier to its subscribers, and thus, each database 54P respective to each application 58P maintains subscriber data that is pertinent to its associated application 58P.

For example, application 58P-1 can be a customer relationship manager (“CRM”) application, being a software solution that helps the carrier manage subscriber relationships in an organized manner. Database 54P-1 would thus contain detailed subscriber information that management and salespeople can reference in order to match subscriber needs with products, and inform subscribers of service requirements.

Continuing with the example, application 58P-2 can be a bundling application, being a software solution that helps the carrier manage subscriber billing, rates, services and the like where that subscriber subscribes to more than one service offered by the carrier. As a specific example, assume that the carrier operating system 50P provided both wireless telephony and cable television services, in which case application 58P-2 would manage relevant subscriber information associated with billing, rates, services and the like for those subscribers that have both wireless telephony and cable television with that carrier. Database 54P-1 would thus contain detailed subscriber information to support the needs of application 58P-2.

Continuing with the example, application 58P-3 can be a location services application, being a software solution that allows some subscribers to ascertain the location of other wireless telephony subscribers provided that pre-defined privacy and permission criteria are met. Database 54P-3 would thus contain detailed subscriber information to identify locations of wireless telephony subscribers who subscriber to the location services application, and to maintain privacy and permission criteria to regulate whether those locations can be divulged on a properly informed inquiry from another subscriber.

Of note, however, is that each database 54P would maintain some common information and some different information than the other databases 54P. More particularly, database 54P-2 would maintain some common, and some different information than database 54P-2, and even the common information may be maintained in each database 54P-1 and 54P-2 in different formats, each format being tailored to its respective application 58P. Likewise, database 54P-3 would maintain some common, and some different information than databases 54P-2 and 54P-2, and even the common information may be maintained in each database 54P in different formats, each format being tailored to its respective application 58P.

There is a need to also ensure that the common contents of each database 54P are synchronized, preferably in real-time or as close as possible thereto. Examples of common contents include obvious information such as the name and address of the subscriber, but those skilled in the art will appreciate that much more complicated information may also be common between various databases 54P, including, for example device type, service plan offering, Mobile Station International Subscriber Directory Number (“MSISDN”), International Mobile Station Identity (“IMSI”), Tariff Plan, Short Message Service (“SMS”) Counter, International Voice Call Minutes, Local Call Minutes, Free Call Counter, Data Volume Usage, Language, Barred Services, and Voucher Recharges. A large list of other information will now occur to those skilled in the art. Synchronization of common data across multiple databases 54P-1 in substantially real-time, into appropriate formats, particularly when system 50P can never be brought “off-line” is non-trivial. Certain prior art achieves synchronization through a synchronization application 62P that resides between each pair of databases 54P to ascertain changes in common data in one database 54P and to update the other database 54P, with appropriate formatting modifications, as quickly as possible. In the example shown in FIG. 1, synchronization application 62P-1 resides between database 54P-1 and database 54P-3; synchronization application 62P-2 resides between database 54P-1 and database 54P-2; and synchronization application 62P-3 resides between database 54P-2 and database 54P-3.

Those skilled in the art will appreciate that system 50P is highly simplified for the purpose of simplified explanation only, and that a carrier will typically be operating far more than three applications 58P, and is likely to be operating dozens of applications 58P that all have respective databases 54P that need to be synchronized according to the preceding discussion. Examples of applications 58P include Virtual Private Networking, Location Based Billing, Prepaid, Missed Call Return, Loyalty Rewards and Promotion Program, Fraud Management, Policy Management, Call Screening and Redirection. An example of a policy management application can include the policy management application described in Applicant's copending U.S. patent application Ser. No. 11/626,111, “Policy Services”, filed Jan. 23, 2007, the contents of which are incorporated herein by reference. Thus, in addition to the example list of fields in the previous paragraph, any of the fields associated with these applications could also be of interest in the databases discussed herein. Of course, to remain competitive, a carrier should also be equipped to handle the addition of new applications 58P as service offerings increase. The result, according to the prior art, is an O(n²) problem of providing sufficient synchronization applications 62P between all databases 54P. The addition of even one more database 54P and application 58P to system 50P dramatically increases the number of synchronization applications 62P, making efficiency and the target of substantially real-time synchronization extremely difficult. Further complications arise where more than one vendor is employed to provide different applications 58P. The synchronization application 62P increase in complexity on a non-linear basis with the addition of additional applications with disparate database structures. To the extent that the introduction of a new field is required across a number of applications (e.g. promotion subscription flag)—this results in a change to the synchronization applications 62P as well as the associated application 58P, thereby increasing overall complexity of system 50P on a non-linear basis.

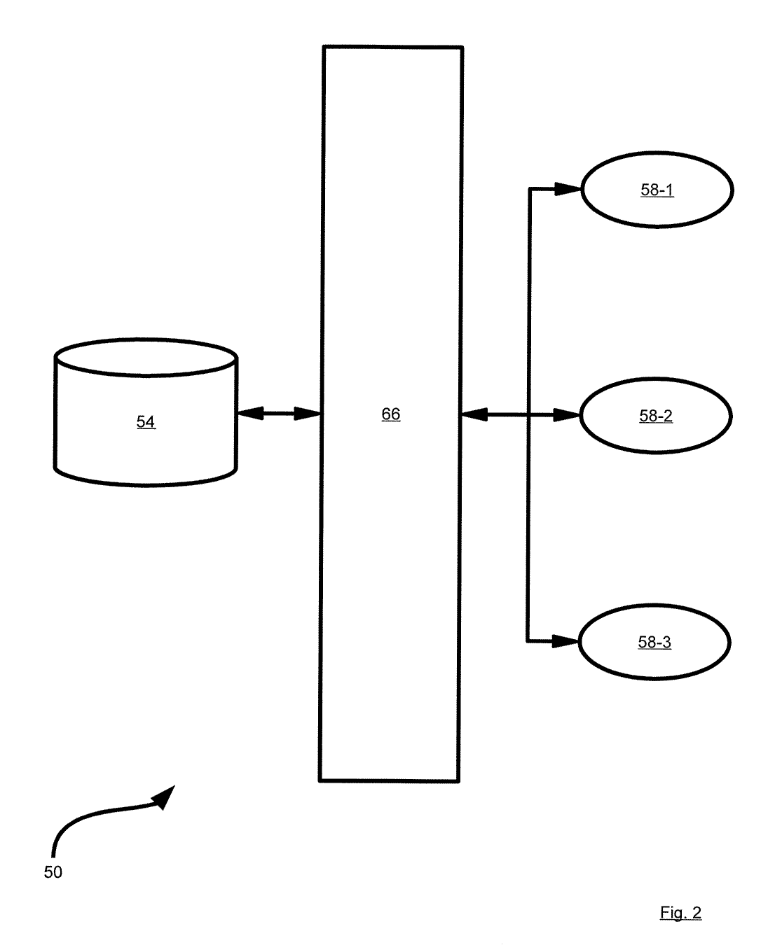

To obviate or mitigate at least one of the disadvantages of the prior art, a present embodiment includes a data repository system 50 as shown in FIG. 2. The components in system 50 contain certain like elements to the components in system 50P, and those bear like reference characters except that the suffix “P” is omitted. System 50P thus comprises a single database 54 that maintains subscriber data for a plurality of applications 58. System 50P also comprises a universal dynamic storage application 66 that resides between database 54 and applications 58.

It should be noted that all of the components in system 50 can be implemented on a variety of hardware platforms, and the choice of hardware platform is not particularly limited. Applications 58 can each reside on one or more servers having a known or future computing environment consisting of, for example, one or more central processing units, random access memory, read only memory, network interfaces, user input and output devices, etc., all interconnected via a bus and executing an operating system that sits between each application 58 and those hardware components. Application 66 would typically reside on its own server, but can also share one or more servers with one or more of applications 58. Database 54 can reside on its own server or servers, with appropriately sized hard disc storage or other persistent storage capacity, and appropriate applications to allow basic database access commands including read, write, delete, etc.

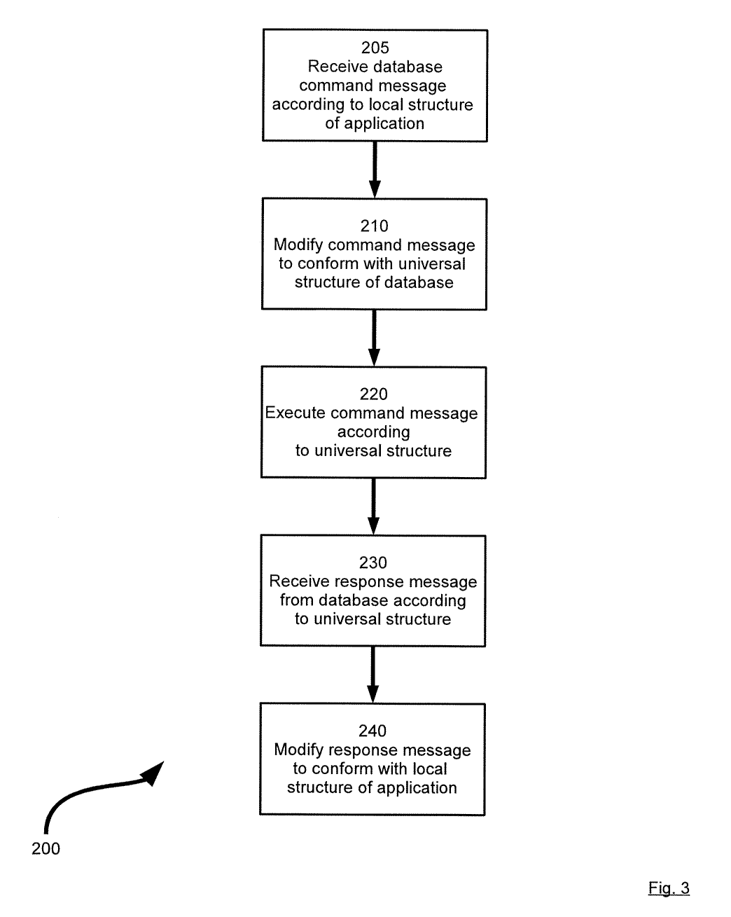

According to another embodiment, a method for operating a data repository is depicted as a flowchart in FIG. 3 and referenced generally at 300. To help better understand method 200 and system 50, method 200 will be discussed in relation to its operation on system 50. However, it should be understood that variations to both method 200 and system 50 are contemplated and they need not be implemented in conjunction in the exact form as shown.

As part of the following discussion, it will be assumed that application 58-1 is the same as the CRM application described in relation to application 58P-1; application 58-2 is the same as the bundling application described in relation to application 58P-2; and that application 58-3 is the same as the location application 58P-3. Thus, each application 58 will rely on certain common data and certain unique data, and the common data can be maintained in different formats. An example of common data, highly simplified for the purpose of explanation only, that is utilized for all three applications 58 is a name that identifies a particular subscriber. (It will be appreciated that the name of a subscriber is only one of hundreds, or even thousands, of database records that may be stored in database 54 and utilized across one or more applications 88). Other illustrative examples of common data include subscriber data such as preference information, subscribed features, billing account information, passwords, and digital rights management data, class of service data, demographic data (e.g. age, sex), subscribed groups, lists of origination/destination addresses or applications and services that are disallowed, lists of origination/destination addresses or applications and services that are allowed, and loyalty programs.

CRM application 58-1, for the purpose of this example, utilizes the name of a particular subscriber in the format shown in Table I. The format of the name is chosen to conform to the overall needs of the customer resource management functions. In the case of Table I, the format is fulsome and contains the full name of the subscriber, so that the CRM application can have the most information possible to meet the subscriber's needs. In Table I, in the example, the subscriber is identified by her full name, Susan Henrietta Smith. In Table I, permissions are also defined for each field, indicating that the user of CRM application 58-1 can read and write any of the fields in Table I.

TABLE I
Format of name in CRM application 58-1

| | | Example Record | |
|---|---|---|---|
| Field Number | Field | Contents | Permissions |
| 1 | Last Name | Smith | Read/Write |
| 2 | First Name | Susan | Read/Write |
| 3 | Middle Name | Henrietta | Read/Write |

Bundling application 58-2, for the purpose of this example, utilizes the name of a particular subscriber in the format shown in Table II. The format of the name is chosen to conform to the overall needs of the bundling function. In the case of Table II, the format is sufficient to clearly identify the subscriber, which is sufficient for the bundling application, but is not as comprehensive as the format of information is found in Table I. Most notably, only the middle initial of the subscriber is recorded in Table II. In Table II, in the example, the subscriber is identified by her first and last name plus middle initial, Susan H. Smith. In Table II, permissions are also defined for each field, indicating that the user of bundling application 58-2 can only read the fields in Table II.

TABLE II
Format of name in bundling application 58-2

| | | Example Record | |
|---|---|---|---|
| Field Number | Field | Contents | Permissions |
| 1 | First Name | Susan | Read |
| 2 | Middle Initial | H | Read |
| 3 | Last Name | Smith | Read |

Location application 58-3, for the purpose of this example, utilizes the name of a particular subscriber in the format shown in Table III. The format of the name is chosen to conform to the overall needs of the bundling function. In the case of Table III, the format is sufficient to identify the subscriber, while keeping the nature of the identification as small as possible, so that the text that identifies is suitably shortened in order to fit on the limited size display of a portable client device that may be used to make the location inquiry. In Table III, in the example, the subscriber is identified by her initials only, SHS. In Table III, permissions are also defined for each field, indicating that the user of bundling application 58-3 can only read the field in Table III.

TABLE III
Format of name in location application 58-3

| | | Example Record | |
|---|---|---|---|
| Field Number | Field | Contents | Permissions |
| 1 | Initials | SHS | Read |

Application 66 is configured to be aware of the formatting specifications of each application 58, and to serve as a conduit to database 54. Database 54 is thus configured to maintain the name of the particular subscriber in the format shown in Table IV.

TABLE IV
Format of name in database 54

| Field Number | Field | Example Record Contents |
|---|---|---|
| 1 | Last Name | Smith |
| 2 | First Name | Susan |
| 3 | Middle Name | Henrietta |

The format of the name in Table IV is chosen to contain information corresponding to the needs of all of the applications 58. In the case of Table IV, the format is identical to the format of Table I, but not identical to the formats of Table II and Table III, though it is not necessary that database 54 have a common format to any of the needs of applications 58.

The format of each table associated with each application 58 (i.e. Tables I, II and III) can be constrained to having the same as the format as the universal Table IV. However, where the formats are different, as is the case in Tables II and III, which have different formats than Table IV, then Tables II and III can be constrained to only have limited permissions to only read the data in Table IV, and not to write to Table IV. This can be acceptable in certain situations, such as the present situation, since Tables II and III only require a subset of the full information stored in Table IV.

Referring now to method 200 of FIG. 3, beginning first at step 205 a database command message according to the local structure of an application is received. In system 50, method 200 is performed by application 66 and accordingly the database command message at step 205 is received at application 66 from any one of applications 58. Assume, for example, the database message command is from location application 58-3 in the form of “retrieve initials of subscriber”. Thus, next, at step 210 application 66 will modify the command message received at step 205 from application 58-3 into a format that conforms to the structure of database 54. In this case, application 66 will generate the command message for database 54 in the form of “retrieve last name, first name and middle name of subscriber”. At step 220, application 66 will forward the message formed at step 210 to database 54. In turn, database 54 will return the contents of Table IV to application 66, which will be received by application 66 at step 230. Next, at step 240, the response message received at step 230 will be modified to conform to the local structure of the application that made the initial request at step 205. In this example, application 66 will extract the initials of the subscriber from the contents of Table IV and place in the form of the contents of Table III, and forward the contents of Table III to location application 58-3. Those skilled in the art will now recognize how a command message from application 58-1 or application 58-2 to retrieve the name of the subscriber would be handled by application 66 in accordance with method 200. Thus, from the perspective application 58-1, it is interacting with a database in the form of Table I; from the perspective application 58-2, it is interacting with a database in the form of Table II; from the perspective application 58-3, it is interacting with a database in the form of Table III; while they are interacting with database 54, which has its own form, all being done in a transparent manner to each application 58. This greatly simplifies the programming parameters that are needed to configure each application 58, thereby reducing programming complexity and improving efficiency.

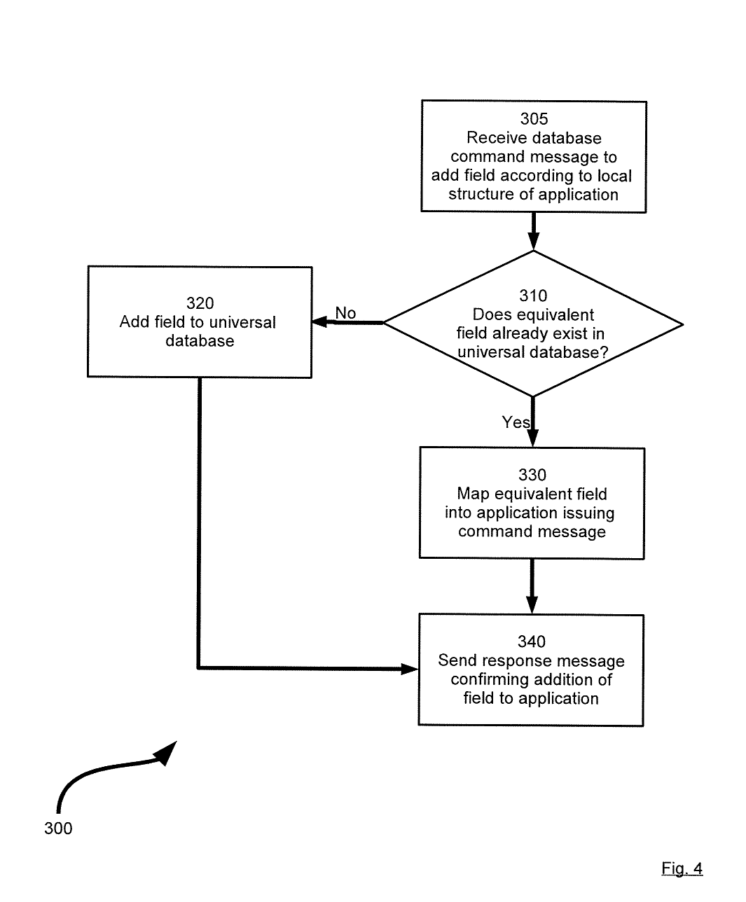

It will now be apparent to those skilled in the art that method 200 is not limited to simple “retrieve” database message commands, but can also be used for other database commands including commands to add, update, copy, delete, modify etc. the contents of the database, and/or also command that actually modify the structure of the database itself. Thus, for example, application 58-3 can be equipped with the functionality to allow it to “modify” the structure of Table III, via application 66 and method 200, but in fact such modification is virtual, giving the appearance to application 58-3 that modification is being effected, while a different modification is being effected to database 54 itself, all under the control of application 66. This example is shown in greater detail in FIG. 4, which includes a flow-chart depicting a method of adding a database field, and which is indicated generally at 300. At step 305, a database command message is received to add a field to the database according to the local structure of the application that issues the message. To help explain the example, assume at step 305 that location application 58-3 issues a command message to application 66 to add the field “Last Name”. Since the “Last Name” field already exists in database 54 (see Table IV), the in this example method 300 would advance from step 310 to step 330 and application 66 would note that application 58-3 now includes a second field entitled “Last Name”, the contents of which are derived from field 1 of Table IV. Table III would then be updated to the format of Table V.

TABLE V
Format of name in location application 58-3 as updated
during exemplary performance of method 300

| | | Example Record | |
|---|---|---|---|
| Field Number | Field | Contents | Permissions |
| 1 | Initials | SHS | Read |
| 2 | Last Name | Smith | Read |

Another exemplary illustration of the performance of method 300 includes the addition of a field that did not previously exist in database 54. In this example, at step 305 assume that application 58-2 issues a command message to add a field entitled “Does subscriber subscribe to cable television services”. At step 310, it would be determined by application 66 that such an equivalent field does not already exist in database 54, and database 54 would be updated accordingly. Table II and Table IV would then be updated at step 320 to add the additional field. Table II would be updated to the form shown in Table VI, while Table IV would be updated to the form shown in Table VII. Note that Table VI is updated to show that Field number 4 can both be read and written to.

TABLE VI
Format of name in bundling application 58-2 as updated
during exemplary performance of method 300

| | | Example Record | |
|---|---|---|---|
| Field Number | Field | Contents | Permissions |
| 1 | First Name | Susan | Read |
| 2 | Middle Initial | H | Read |
| 3 | Last Name | Smith | Read |
| 4 | Does subscriber | Yes | Read/Write |
| | subscribe to cable | | |
| | television services | | |

TABLE VII
Format of name in database 54

| | | Example Record |
|---|---|---|
| Field Number | Field | Contents |
| 1 | Last Name | Smith |
| 2 | First Name | Susan |
| 3 | Middle Name | Henrietta |
| 4 | Does subscriber subscribe to | Yes |
| | cable television services | |

It will now be apparent to those of skill in the art that numerous other operations can be effected by application 66, including changes to both table structure and table contents.

It will also now be apparent that where database 54 includes many fields, it can be desired to include functionality in application 66 to handle incompatibilities between the local structure used by each application 58 and database 54 itself, particularly where handling of those incompatibilities is not readily automated. In this case, application 66 can include a “viewing strategy” field associated with each field in database 54, which informs application 66 what to do where incompatibilities are difficult to resolve. This can be important where the contents or format of data are particularly sensitive to one or more of the applications 58. The viewing strategy can include one or more of the following options that are available for each field in database 54 including “alter”; “migrate”; “extend”; “ignore”; “alarm”; and “recreate”. The “alter” field can be an instruction for application 66 to issue an “alter” command according to Structured Query Language (“SQL”) to database 54 in order to effect the instruction of application 58. The “migrate” command can be a command to export, drop, recreate and import the database field in database 54. The “extend” command can be a command to add extra fields, but not to remove old ones. The “ignore” command can be a command to ignore instructions from application 58 pertaining to that corresponding field in database 54. The “alarm” command can be a command to notify a system administrator of application 66 of the incompatibility, but to otherwise ignore instructions from application 58 pertaining to that field in database 54. The “recreate” command can be a command to drop and recreate that field in database 54. Other strategies will now occur to those skilled in the art.

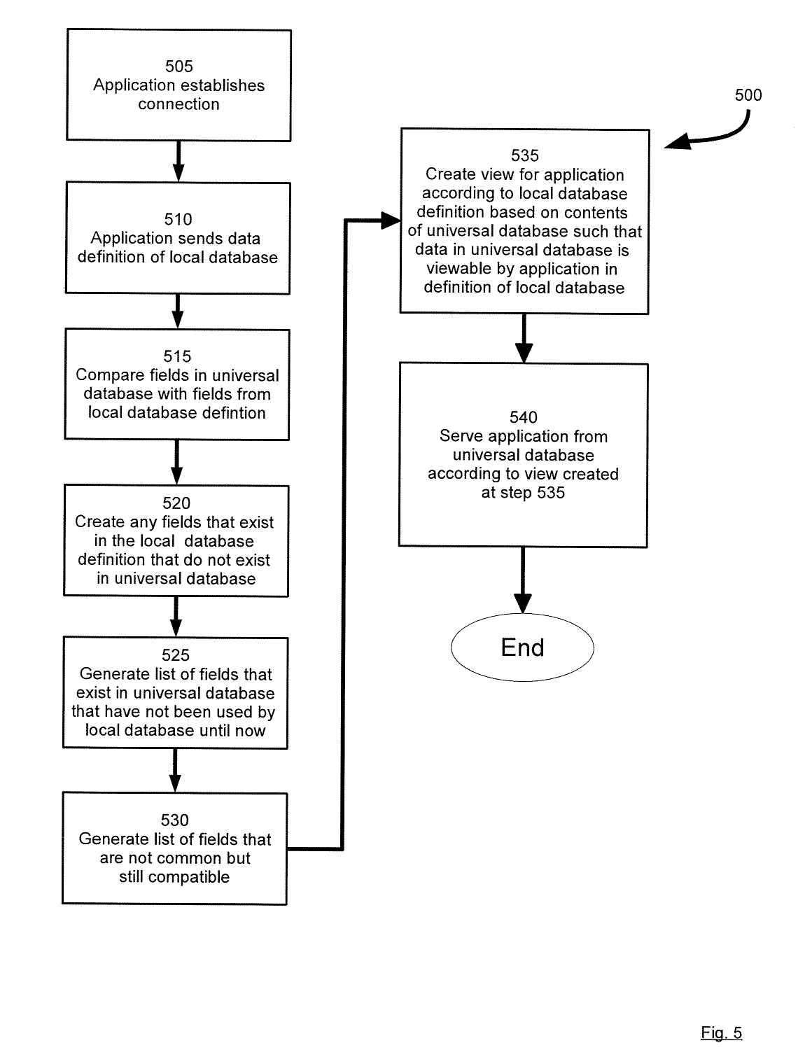

According to another embodiment, a method for operating a data repository is depicted as a flowchart in FIG. 5 and referenced generally at 500. To help better understand method 500 and system 50, method 500 will be discussed in relation to its operation on system 50. However, it should be understood that variations to both method 500 and system 50 are contemplated and they need not be implemented in conjunction in the exact form as shown.

Again, as part of the following discussion, it will be assumed that application 58-1 is the same as the CRM application described in relation to application 58P-1; application 58-2 is the same as the bundling application described in relation to application 58P-2; and that application 58-3 is the same as the location application 58P-3. Thus, each application 58 will rely on certain common data and certain unique data, and the common data can be maintained in different formats. Again, as according to the earlier example, the name that identifies a particular subscriber is used as an example of data that is utilized for all three applications 58.

Thus, CRM application 58-1, for the purpose of this example, utilizes the name of a particular subscriber in the format shown in Table VIII. The format of the name is chosen to conform to the overall needs of the customer resource management functions. In the case of Table VIII, the format is fulsome and contains the full name of the subscriber, so that the CRM application can have the most information possible to meet the subscriber's needs. In Table VIII, in the example, the subscriber is identified by her full name, Susan Henrietta Smith. In Table VIII, permissions are also defined for each field, indicating that the user of CRM application 58-1 can read and write any of the fields in Table I.

TABLE VIII
Format of name in CRM application 58-1

| | | Example Record | |
|---|---|---|---|
| Field Number | Field | Contents | Permissions |
| 1 | Last Name | Smith | Read/Write |
| 2 | First Name | Susan | Read/Write |
| 3 | Middle Name | Henrietta | Read/Write |

Bundling application 58-2, for the purpose of this example, utilizes the name of a particular subscriber in the format shown in Table IX. The format of the name is chosen to conform to the overall needs of the bundling function. In the case of Table IX, the format is sufficient to clearly identify the subscriber, which is sufficient for the bundling application, but is not as comprehensive as the format of information is found in Table IX. Most notably, only the middle initial of the subscriber is recorded in Table IX. In Table IX, in the example, the subscriber is identified by her first and last name plus middle initial, Susan H. Smith. In Table IX, permissions are also defined for each field, indicating that the user of bundling application 58-2 can only read the fields in Table IX.

TABLE IX
Format of name in bundling application 58-2

| | | Example Record | |
|---|---|---|---|
| Field Number | Field | Contents | Permissions |
| 1 | First Name | Susan | Read |
| 2 | Middle Initial | H | Read |
| 3 | Last Name | Smith | Read |

Location application 58-3, for the purpose of this example, utilizes the name of a particular subscriber in the format shown in Table X. The format of the name is chosen to conform to the overall needs of the bundling function. In the case of Table X, the format is sufficient to identify the subscriber, while keeping the nature of the identification as small as possible, so that the text that identifies is suitably shortened in order to fit on the limited size display of a portable client device that may be used to make the location inquiry. In Table X, in the example, the subscriber is identified by her initials only, SHS. In Table X, permissions are also defined for each field, indicating that the user of bundling application 58-3 can only read the field in Table III.

TABLE X
Format of name in location application 58-3

| | | Example Record | |
|---|---|---|---|
| Field Number | Field | Contents | Permissions |
| 1 | Initials | SHS | Read |
| 2 | Location | Madrid | Read/Write |

Application 66 is configured to be aware of the formatting specifications of each application 58, and to serve as a conduit to database 54. Database 54 is thus configured to maintain the name of the particular subscriber in the format shown in Table XI.

TABLE XI
Format of name in database 54

| Field Number | Field | Example Record Contents |
|---|---|---|
| 1 | Last Name | Smith |
| 2 | First Name | Susan |
| 3 | Middle Name | Henrietta |

The format of the name in Table XI is chosen to contain information corresponding to the needs of all of the applications 58. In the case of Table XI, the format is identical to the format of Table VII, but not identical to the formats of Table IX and Table X.

Beginning at step 505, an application establishes a connection with a universal storage application. To explain performance of step 505, it will be assumed that application 58-1 establishes a connection with application 66. Next, at step 510, the application sends the data definition of local database to the universal storage application. Continuing with the example, to perform step 510 application 58-1 would the schema of Table VIII to application 66, including the list of the fields, and other definitions such as field type, field length etc. (not shown in Table VIII) to application 66.

Next, at step 515, a comparison is performed between the data definition from step 510 with the fields of the universal database. Continuing with the example, to perform step 515 application 66 will compare the schema of Table VIII with the schema of Table XI.

Next, at step 520, based on the comparison done at step 515, fields that exist in the local database definition which do not exist in the universal database are created in the universal database. In the present example, all the fields in the local database definition (i.e. the schema of Table VIII) already exist in the definition of database 54 (i.e. the schema of Table X), and accordingly, no new fields are created.

Next, based on the comparison done at step 515, at step 525 a list of fields are created that include the list of fields that exist in the universal database but that have not been used, until now, in the local database definition. Continuing with the example, the comparison done by application 66 at step 525 would generate no list of fields, since there are no fields in the universal database definition that have not been used, until now by the local database definition.

Next, based on the comparison done at step 515, at step 530 a list of fields are created that include the list of fields that are not in common between the universal database and the local database definition, but which fields are nonetheless compatible. Continuing with the example, the comparison done by application 66 at step 530 would generate no list of fields, since there are all the fields in the universal database definition are in common with the fields in the local database definition.

Next, at step 535, a view is created, based on the results of steps 520-530, for the local application which accords with the local database definition but is based on the contents of the universal database, such that the data in the universal database is viewable by the application in accordance with the definition of the local database. In the present example, the view that is created at step 535 substantially represents the definition of Table X, since the definition of the universal database 54 is already the same as the definition of the database local to application 58-1. The resulting view, created at step 535, thus presents Table VIII to application 58-1, as if Table VIII was a database locally connected to and dedicated to application 58-1. Thus, at step 540, application 58-1 is served by application 66 according to the view that was created at step 535.

Those skilled in the art will now appreciate that the foregoing discussion represented a simple case. To help further understand method 500, another exemplary performance of method 500 will be provided. Beginning at step 505, an application establishes a connection with a universal storage application. To explain performance of step 505, it will be assumed that application 58-3 establishes a connection with application 66. Next, at step 510, the application sends the data definition of local database to the universal storage application. Continuing with the example, to perform step 510 application 58-3 would the schema of Table X to application 66, including the list of the fields, and other definitions such as field type, field length etc. (not shown in Table X) to application 66.

Next, at step 515, a comparison is performed between the data definition from step 510 with the fields of the universal database. Continuing with the example, to perform step 515 application 66 will compare the schema of Table VIII with the schema of Table X.

Next, at step 520, based on the comparison done at step 515, fields that exist in the local database definition which do not exist in the universal database are created in the universal database. In the present example, Field 2 of Table X, Location, does not exist in Table XI. Accordingly, at step 520, Field 2 would be created in Table X. As a result of performing step 520 by application 66 according to this example, Table XI would be updated according to the appearance of Table XII.

TABLE XII
Format of name in database 54 after performance
of step 520 according to contents of Table X

| Field Number | Field | Example Record Contents |
|---|---|---|
| 1 | Last Name | Smith |
| 2 | First Name | Susan |
| 3 | Middle Name | Henrietta |
| 4 | Location | Madrid |

Next, based on the comparison done at step 515, at step 525 a list of fields are created that include the list of fields that exist in the universal database but that have not been used, until now, in the local database definition. Continuing with the example, the comparison done by application 66 at step 525 would generate no list of fields, since there are no fields in the universal database definition that have not been used, until now by the local database definition.

Next, based on the comparison done at step 515, at step 530 a list of fields are created that include the list of fields that are not in common between the universal database and the local database definition, but which fields are nonetheless compatible. Continuing with the example, the comparison done by application 66 at step 530 would generate list of fields which cross references between Field 1 of Table X, and Fields 1-3 of Table XII, since the contents of Field 1 of Table X can be derived from the first character of the contents of Fields 1-3 of Table XII, provided that it be clear that application 58-3 cannot update the contents of Field 1 of Table X since that field is derived from, and only a portion of, the contents Fields 1-3 of Table XII.

Next, at step 535, a view is created, based on the results of steps 520-530, for the local application which accords with the local database definition but is based on the contents of the universal database, such that the data in the universal database is viewable by the application in accordance with the definition of the local database. In the present example, the view that is created at step 535 is derived from the contents of Table XII in order to create a view consistent with the contents of Table X, whereby Field 1 of Table X is derived from the first characters of Fields 1-3 of Table XII. The resulting view, created at step 535, can thus present Table X to application 58-3, as if Table X was a database locally connected to and dedicated to application 58-3.

To help further understand method 500, another exemplary performance of method 500 will be provided. During this example, it will be assumed that database 54 has contents consistent with Table XII, as generated during the previous exemplary performance of method 500. It will also be assumed that application 58-2 has accessed database 54 via method 500 on previous occasions based on the contents of Table IX, but that, just prior to this exemplary performance of method 500, application 58-2 has been updated such that a new database definition for application 58-2 has been created, which is in accordance with Table XIII.

TABLE XIII
Format of name in bundling application 58-2 as updated from Table IX

| | | Example Record | |
|---|---|---|---|
| Field Number | Field | Contents | Permissions |
| 1 | First Name | Susan | Read |
| 2 | Middle Initial | H | Read |
| 3 | Last Name | Smith | Read |
| 4 | Location | Madrid | Read/Write |

Beginning at step 505, an application establishes a connection with a universal storage application. To explain performance of step 505, it will be assumed that application 58-2 establishes a connection with application 66. Next, at step 510, the application sends the data definition of local database to the universal storage application. Continuing with the example, to perform step 510 application 58-2 would the schema of Table XIII to application 66, including the list of the fields, and other definitions such as field type, field length etc. (not shown in Table XIII) to application 66. (Recall, however, that on previous performances of method 500 application 58-2 would have sent the schema of Table IX.)

Next, at step 515, a comparison is performed between the data definition from step 510 with the fields of the universal database. Continuing with the example, to perform step 515 application 66 will compare the schema of Table XIII with the schema of Table XII.

Next, at step 520, based on the comparison done at step 515, fields that exist in the local database definition which do not exist in the universal database are created in the universal database. In the present example, there are no new fields and so no new fields are created in the universal database.

Next, based on the comparison done at step 515, at step 525 a list of fields are created that include the list of fields that exist in the universal database but that have not been used, until now, in the local database definition. Continuing with the example, the comparison done by application 66 at step 525 would generate a list that included Field 4 of XIII and Field 4 of Table XII, noting that up until this point, application 58-2 had not sent a database definition that utilized the “Location” field, but on this occasion, application 58-2 is now indicating utilization of the “Location” field.

Next, based on the comparison done at step 515, at step 530 a list of fields are created that include the list of fields that are not in common between the universal database and the local database definition, but which fields are nonetheless compatible. Continuing with the example, the comparison done by application 66 at step 530 would generate list of fields which cross references between Field 2 of Table XII, and Field 2 of Table XIII, since the contents of Field 2 of Table XIII can be derived from the first character of the contents of Field 2 of Table XII, provided that it be clear that application 58-2 cannot update the contents of Field 2 of Table XII since that field is derived from, and only a portion of the contents Field 2 of Table XII.

Next, at step 535, a view is created, based on the results of steps 520-530, for the local application which accords with the local database definition but is based on the contents of the universal database, such that the data in the universal database is viewable by the application in accordance with the definition of the local database. In the present example, the view that is created at step 535 is derived from the contents of Table XII in order to create a view consistent with the contents of Table XIII, whereby Field 2 of Table XII is derived from the first character of Field 2 of Table XIII. The resulting view, created at step 535, can thus present Table XII to application 58-3, as if Table XII was a database locally connected to and dedicated to application 58-2.

While various specific combinations of the various features and components of the present invention have been discussed herein, it will be apparent to those of skill in the art that variations, subsets and combinations of the disclosed features and components can be effected, as desired. For example, the various previously described embodiments can be combined, or subsets of those embodiments combined. As another example, the steps in the various methods discussed herein need not be performed in the exact sequence as shown, and/or certain steps may be performed in parallel or substantially in parallel. For example, steps 520-530 of method 500 can be performed in any sequence, or can be performed in parallel, or in combinations thereof. Other such variations in the various methods will now occur to those skilled in the art.

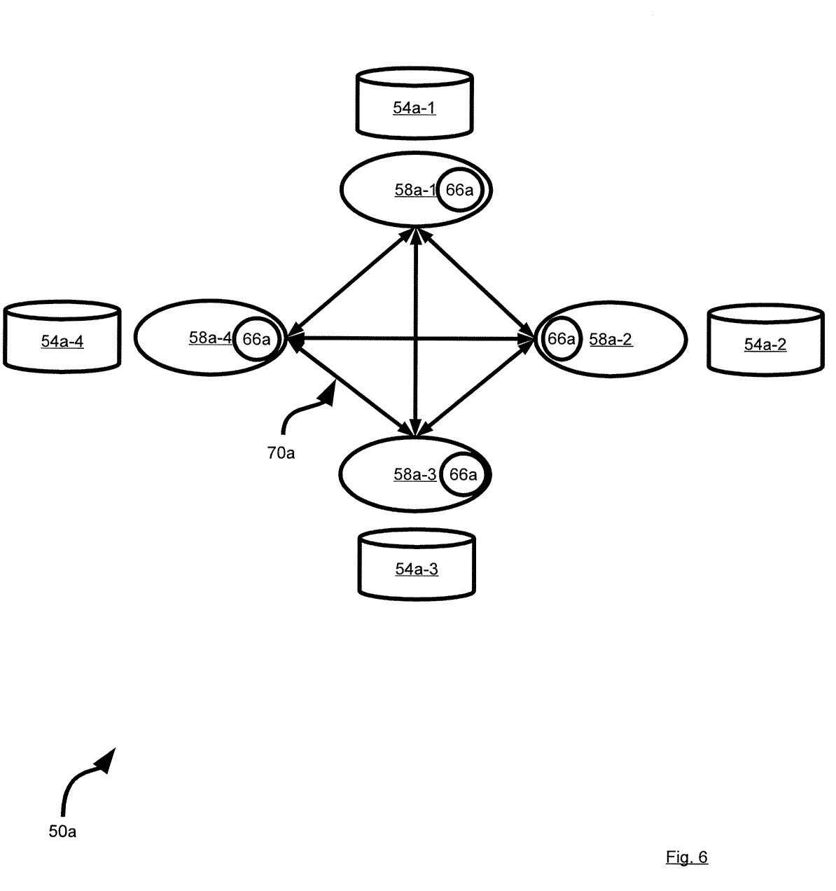

One such variation is shown in FIG. 6, which shows a data repository system 50a. System 50a includes many of the same components as system 50 and like components bear like reference characters, except followed by the suffix “a”. Of note, in system 50a each application 58a has its own associated database 54a. Also of note is that in system 50a application 66 is implemented in a distributed manner as a peer-to-peer application 66a that is embedded within (or operationally associated with) each application 58. Collectively applications 66a operate together via peer-to-peer links 70a to implement substantially the same functionality as application 66. Likewise, database 54 from system 50 is implemented in a distributed, peer-to-peer manner, as a plurality of database 54a. In this manner, database fields which are common to all applications 58 can be stored on only one of the databases 54a, with peer-to-peer applications 66a implementing a suitably modified version of method 200 and/or method 500 in order commonly share, in formats local to each application 58a, those common database fields. Database fields which are unique to each application 58a are typically stored on the database 54a that is local/respective to that application 58a. However, should another application 58a seek to utilize database fields that are associated with another application 58a, then peer-to-peer application 66a can transparently facilitate access to those database fields without duplication of those same fields

It should now be apparent that a hybrid version of system 50a and system 50 can also be implemented, with some database fields being held in a single, common database and other fields being held in distributed databases.

The above-described embodiments of the invention are intended to be examples of the present invention and alterations and modifications may be effected thereto, by those of skill in the art, without departing from the scope of the invention which is defined solely by the claims appended hereto.

1. A method of operating a data repository comprising:
receiving a local database definition from a local application that utilizes said local database definition;
comparing fields in a universal database with said local database definition;
generating a viewing strategy for said local application; said viewing strategy based on results of said comparing;
creating a view for said local application according to said local database definition based on said viewing strategy such that data in said universal database is viewable in said local application according to said local database definition.

2. The method of claim 1 further comprising the step of serving said local application from said universal database according to said view.

3. The method of claim 1 wherein said viewing strategy includes generating a list of fields that exist in said universal database that have not been used in said local database definition until now.

4. The method of claim 1 wherein said viewing strategy includes generating a list of fields that are not common between said universal database and said local database definition but which are compatible.

5. The method of claim 4 further comprising establishing read only privileges for said local database definition for said fields which are compatible but not in common.

6. The method of claim 4 wherein said list of fields include fields in said local database definition that contain only a portion of fields from said universal database.

7. The method of claim 4 wherein said list of fields include fields in said local database definition that are derived from multiple fields in said universal database.

8. The method of claim 1 further comprising the step of creating fields in said universal database that exist in said local database definition but do not exist in said universal database.

9. The method of claim 1 wherein fields in said local database include one or more of subscriber name, device type, service plan offering, Mobile Station International Subscriber Directory Number (“MSISDN”), International Mobile Station Identity (“IMSI”), Tariff Plan, Short Message Service (“SMS”) Counter, International Voice Call Minutes, Local Call Minutes, Free Call Counter, Data Volume Usage, Language, Barred Services, and Voucher Recharges.

10. The method of claim 1 wherein said application can be one of a customer resource management application, a bundling application, a location application, a Virtual Private Networking application, a Location Based Billing application, a Prepaid billing application, a Missed Call Return application, a Loyalty Reward and Promotion Program application, a Fraud Management application, a Policy Management application, a Call Screening and Redirection application.

11. A data repository system comprising:
a universal database;
a universal database application connected to said universal database;
a plurality of local applications connected to said universal database application; each of said a local database configured to utilize a local database definition;
said universal database application configured to receive each said local database definition from said local application and to perform a comparison of fields in said universal database with said local database definition; said universal database application further configured to generate a viewing strategy for said local application; said viewing strategy based on results of said comparison; said universal database application further configured to create a view for said local application according to said local database definition based on said viewing strategy such that data in said universal database is viewable in said local application according to said local database definition.

12. The system of claim 11 wherein said universal database application is further configured to serve said local application from said universal database according to said view.

13. The system of claim 11 wherein said viewing strategy includes a list of fields that exist in said universal database that have not been previously used in said local database definition.

14. The system of claim 11 wherein said viewing strategy includes a list of fields that are not common between said universal database and said local database definition but which are compatible.

15. The system of claim 14 wherein said universal database application enforces read only privileges for said local database definition for said fields which are compatible but not in common.

16. The system of claim 14 wherein said list of fields include fields in said local database definition that contain only a portion of fields from said universal database.

17. The system of claim 14 wherein said list of fields include fields in said local database definition that are derived from multiple fields in said universal database.

18. The system of claim 11 further comprising the step of creating fields in said universal database that exist in said local database definition but do not exist in said universal database.

19. The system of claim 11 wherein fields in said local database include one or more of subscriber name, device type, service plan offering, Mobile Station International Subscriber Directory Number (“MSISDN”), International Mobile Station Identity (“IMSI”), Tariff Plan, Short Message Service (“SMS”) Counter, International Voice Call Minutes, Local Call Minutes, Free Call Counter, Data Volume Usage, Language, Barred Services, and Voucher Recharges.

20. The system of claim 11 wherein said local application can be one of a customer resource management application, a bundling application, a location application, a Virtual Private Networking application, a Location Based Billing application, a Prepaid billing application, a Missed Call Return application, a Loyalty Reward and Promotion Program application, a Fraud Management application, a Policy Management application, a Call Screening and Redirection application, a Subscriber Profile Management application.

21. A method of operating a data repository comprising:
receiving a database command message in a local structure from one of a plurality of applications; each of said applications associated with its own local formats; each of said local formats sharing at least one common field;
modifying said database command message from said local format to conform with a universal database structure;
forwarding said command message in said universal database structure to a common database;
receiving a response message, responsive to said command message; from said common database in said universal database structure;
modifying said response message to conform to said local format; and
returning said response to said command message in said local format to said one of said plurality of applications.
